(19) United States
(12) Patent Application Publication
(10) Pub. No.: US 2026/0153465 A1
(43) Pub. Date: Jun. 4, 2026

(54) MANUFACTURING METHOD FOR SECONDARY BATTERY

(71) Applicant: SK ON CO., LTD., Seoul (KR)

(72) Inventors: Dong Min JEONG, Daejeon (KR); Hye Ju JANG, Daejeon (KR)

(21) Appl. No.: 19/398,058

(22) Filed: Nov. 24, 2025

(30) Foreign Application Priority Data
Dec. 4, 2024 (KR) 10-2024-0178559

(51) Int. Cl. G01N 25/72; H01M 50/186

(52) U.S. Cl. CPC G01N 25/72; H01M 50/186

(57) ABSTRACT

Proposed is a manufacturing method for a secondary battery. The method may include transporting a secondary battery, detecting temperature of the secondary battery being transported in the transporting of the secondary battery, and determining whether the secondary battery is defective on the basis of temperature information obtained from the detecting of the temperature.

### CROSS REFERENCE TO RELATED APPLICATION

The present application claims priority to Korean Patent Application No. 10-2024-0178559, filed Dec. 4, 2024, the entire contents of which is incorporated herein for all purposes by this reference.

### BACKGROUND

### Technical Field

The present disclosure relates to a manufacturing method for a secondary battery.

### Description of the Related Art

In general, a secondary battery is a reusable battery that converts chemical energy into electrical energy during discharge and then can be recharged by converting electrical energy back into chemical energy.

Secondary batteries may include nickel-cadmium (Ni—Cd) batteries, nickel-hydrogen (Ni-MH) batteries, lithium-metal batteries, lithium-ion (Li-Ion) batteries, and lithium-ion polymer batteries.

Among secondary batteries, lithium secondary batteries have an expected lifespan of around 500 cycles and a short charging time of about 1 to 2 hours. Lithium secondary batteries are about 30 to 40% lighter than nickel-hydrogen batteries, allowing for weight reduction. Lithium secondary batteries generally have the highest voltage per unit cell among commonly used secondary batteries, and possess excellent energy density, making them ideal for mobile devices.

### SUMMARY

According to an aspect of the present disclosure, provided is a manufacturing method for a secondary battery, the method enabling inspection of sealing quality of a secondary battery.

According to another aspect of the present disclosure, provided is a manufacturing method for a secondary battery, wherein the method can be widely applied to green technology fields such as electric vehicles, battery charging stations, and solar and wind power generation systems that use energy storage batteries.

A manufacturing method for a secondary battery according to an embodiment of the present disclosure may include: transporting a secondary battery; detecting the temperature of the secondary battery being transported in the transporting of the secondary battery; and determining whether the secondary battery is defective on the basis of temperature information obtained from the detecting of the temperature.

In the detecting of the temperature, when the temperature of the secondary battery is detected, the transport of the secondary battery may be stopped for a predetermined time and then the secondary battery may be transported again.

In the detecting of the temperature, the temperature of the secondary battery may be detected using a non-contact temperature measurement means of either a thermal imaging camera or an infrared temperature sensor.

In case that the information shows that the temperature is 30° C. or higher, the secondary battery may be determined as a good product in the determining whether the secondary battery is defective.

The method may further include detecting a position of the secondary battery being transported in the transporting of the secondary battery.

In the detecting of the position, presence or absence of the secondary battery may be detected at a position where the temperature of the secondary battery is detected.

In the detecting of the position, the secondary battery is detected after the secondary battery may be transported for a predetermined time in the transporting of the secondary battery.

The method may further include sealing, before the transporting of the secondary battery, a boundary between an accommodation portion that accommodates an electrode assembly and an electrolyte inside the secondary battery and a gas chamber that stores gas generated inside the secondary battery.

In the detecting of the temperature, the temperature of the boundary of the secondary battery may be detected.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, it is possible to inspect the sealing quality of a secondary battery.

According to an embodiment of the present disclosure, the sealing quality of a secondary battery can be inspected using temperature to ensure accurate quality inspection.

In addition, the present disclosure can enable quality inspection and analysis of a desired portion of a secondary battery.

In addition, according to the present disclosure, defects can be identified during secondary battery manufacturing, thereby reducing process loss.

In addition, according to the present disclosure, it is possible to identify defects immediately after the defects occur during secondary battery manufacturing, thereby preventing continuous defect occurrence by resetting process conditions.

### BRIEF DESCRIPTION OF THE DRAWINGS

FIG. 1 is a flowchart showing a manufacturing method for a secondary battery according to an embodiment of the present disclosure.

FIG. 2 is a plan view schematically showing a secondary battery manufactured by a manufacturing method for a secondary battery according to an embodiment of the present disclosure.

FIG. 3 is a perspective view schematically showing a secondary battery manufacturing process by a manufacturing method for a secondary battery according to an embodiment of the present disclosure.

### DETAILED DESCRIPTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

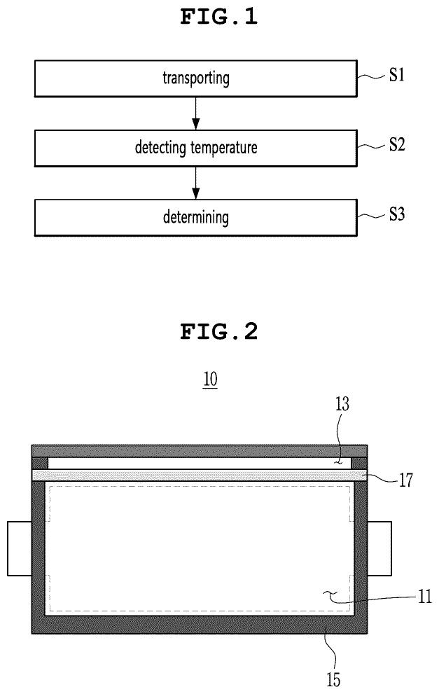

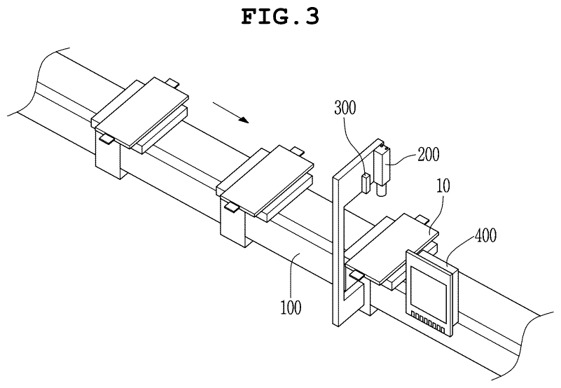

FIG. 1 is a flowchart showing a manufacturing method for a secondary battery according to an embodiment of the present disclosure. FIG. 2 is a plan view schematically showing a secondary battery manufactured by a manufacturing method for a secondary battery according to an embodiment of the present disclosure. FIG. 3 is a perspective view schematically showing a secondary battery manufacturing process by a manufacturing method for a secondary battery according to an embodiment of the present disclosure.

Referring to FIGS. 1 to 3, the manufacturing method for a secondary battery according to an embodiment of the present disclosure may include: a transport step S1 for transporting a secondary battery 10; a temperature detection step S2 for detecting the temperature of the secondary battery 10 transported in the transport step S1; and a determination step S3 for determining whether the secondary battery 10 is defective on the basis of information on the temperature detected in the temperature detection step S2.

Referring to FIG. 2, in an embodiment, the secondary battery 10 may be a pouch type secondary battery.

The secondary battery 10 may include: an accommodation portion 11 that accommodates an electrode assembly and an electrolyte inside a casing; and a gas chamber 13 provided on one side of the accommodation portion 11 and capable of storing gas inside.

The space between the accommodation portion 11 and the gas chamber 13 may be sealed to isolate the accommodation portion 11 and the gas chamber 13 from each other.

Generally, during the manufacturing process of a secondary battery 10, the electrode assembly is accommodated in the accommodation portion 11 inside the casing of the secondary battery 10, and then the electrolyte is injected into the accommodation portion 11 to impregnate the electrode assembly with the electrolyte.

Then, after putting on a lid of the casing, a first sealing portion 15, which is the edge between the casing and the lid, may be primarily sealed.

Then, the secondary battery 10 forms a solid electrolyte interphase (SEI) film on the negative electrode surface thereof during the initial charging and discharging cycles to be activated.

During the battery activation process, the gas generated inside the secondary battery 10 may be stored in the gas chamber 13 and then the gas chamber 13 may be removed.

That is, during the battery activation process, gas is generated inside, and when the pressure inside the secondary battery exceeds a certain level, the sealing portion between the accommodation portion 11 and the gas chamber 13 is destroyed, allowing the gas to flow into the gas chamber 13.

The gas chamber 13 into which the gas has been introduced may be removed from the secondary battery 10.

Before removing the gas chamber 13 from the secondary battery 10, the broken sealing portion at the boundary between the accommodation portion 11 of the secondary battery and the gas chamber 13 may be resealed.

Thus, the manufacturing method for a secondary battery according to an embodiment of the present disclosure may further include: a sealing step, before the transport step S1, for sealing the boundary between the accommodation portion 11 that accommodates the electrode assembly and electrolyte inside the secondary battery 10 and the gas chamber 13 that stores the gas generated inside the secondary battery 10.

After the battery activation process, the secondary battery 10 may be provided with a second sealing portion 17 by sealing the boundary between the accommodation portion 11 and the gas chamber 13 when the gas generated in the accommodation portion 11 containing the electrolyte in the battery activation process flows into the gas chamber 13.

The second sealing portion 17 may be a part where a PP (polypropylene) layer of the casing and a PP layer of the lid, which correspond to the boundary between the accommodation portion 11 and the gas chamber 13, are brought into contact with each other by heating the contact part at a temperature of 150° C. to 180° C. for about 3 seconds so as to be melted.

The transport step S1 may be a step of transporting the secondary battery 10 to the next process using a transport device 100 such as a linear motion system (LMS) or a conveyor belt after the sealing step.

The manufacturing method for a secondary battery according to an embodiment of the present disclosure may further include: a position detection step between the transport step S1 and the temperature detection step S2.

In the position detection step, the position of the secondary battery 10 being transported in the transport step S1 may be detected.

Referring to FIG. 3, in the position detection step, the position of the secondary battery 10 being transported in the transport step S1 may be detected using a detection sensor 300 such as a position detection sensor or a light detection sensor.

In addition, in the position detection step, the presence or absence of the secondary battery may be detected at the position where the temperature of the secondary battery 10 is detected in the temperature detection step S2.

In the position detection step, the secondary battery 10 may be detected after the secondary 10 battery 10 has been transported for a predetermined time (between 33 seconds and 43 seconds) in the transport step S1.

The reason for detecting the position of the secondary battery 10 after the secondary battery 10 has been transported for a predetermined period of time is due to the difference in time taken for heat dissipation between a good product and a defective product in the second sealing portion 17 of the secondary battery 10.

A detailed description of the heat dissipation time of good and bad secondary batteries 10 is provided below along with Table 1.

In the temperature detection step S2, the temperature of the secondary battery 10 may be detected at the position where the secondary battery 10 was detected in the position detection step.

The temperature detection step S2 may be a step of detecting the temperature of the second sealing portion 17, which is the boundary between the accommodation portion 11 and the gas chamber 13 of the secondary battery 10 detected in the position detection step.

In the temperature detection step S2, the temperature of the secondary battery 10 may be detected by a non-destructive inspection technique using any one of a non-contact temperature measurement means such as a thermal imaging camera 200 or an infrared temperature sensor.

The thermal imaging camera 200 may be a non-contact measurement device that detects infrared energy (heat) and converts the detected infrared energy into a visible image.

That is, by detecting the temperature of the secondary battery 10 using the thermal imaging camera 200, the changing temperature may be detected in real time and the temperature may be expressed as imagery, so that the temperature status may be intuitively checked and the overall temperature distribution may be easily checked.

When the temperature of the secondary battery 10 is detected in the temperature detection step S5, the transport of the secondary battery 10 may be stopped for a predetermined time and then the secondary battery 10 may be transported again.

That is, as an embodiment, in the temperature detection step S5, after detecting the temperature of the second sealing portion 17 while the transport of the secondary battery 10 is stopped for 1 to 1.3 seconds, the secondary battery 10 may be transported to the next step.

TABLE 1

| Number of | Experimental | Comparative |
|---|---|---|
| experiments | example (sec) | example (sec) |
| 1 | 42 | 35 |
| 2 | 45 | 35 |
| 3 | 43 | 35 |
| 4 | 43 | 30 |
| 5 | 43 | 30 |

Table 1 compares an experimental example, which is a good product, with a comparative example, which is a defective product.

Table 1 shows a secondary battery 10 in which no electrolyte remains in the PP layer, which is the second sealing portion 17 of the secondary battery 10, as an experimental example, and a secondary battery 10 in which electrolyte remains in the second sealing portion 17 as a comparative example.

In case that the electrolyte remains in the second sealing portion 17 of the secondary battery 10, the sealing quality may deteriorate and the internal insulation in the secondary battery 10 may be destroyed.

Destruction of the internal insulation in the secondary battery 10 may cause a deterioration in performance of the secondary battery 10 and increase fire risk.

For the experimental example and comparative example, the time (sec) taken for heat dissipation is measured after heating for about 3 seconds at a temperature of 150° C. to 180° C., similar to the environment in which the second sealing portion 17 of the secondary battery 10 is fixed in the sealing step.

As shown in Table 1, the experimental example takes an average of 43.2 seconds to dissipate heat, and the comparative example takes an average of 33 seconds to dissipate heat.

That is, when the temperature of the second sealing portion 17 of the secondary battery 10 is detected after a predetermined time (between 33 and 43 seconds) from the time the secondary battery 10 is sealed in the sealing step, residual heat of 30° C. or higher may be detected in the case of a good secondary battery. In the case of a defective secondary battery, residual heat of less than 30° C. may be detected.

Thus, in the position detection step, the secondary battery 10 that has reached a position where the temperature is detected in the temperature detection step S2 is detected between 33 seconds and 43 seconds after fixing the second sealing portion 17 of the secondary battery 10 by heat in the sealing step, and the temperature of the position-detected secondary battery 10 may be detected in the temperature detection step S2.

The determination step S3 may be a step for determining whether the secondary battery 10 is defective on the basis of the temperature of the second sealing portion 17.

When the information obtained from the temperature detection step S2 shows that the temperature of the second sealing portion 17 is 30° C. or higher, the secondary battery 10 may be determined as a good product in the determination step S3.

When the information shows that the temperature of the second sealing portion 17 is less than 30° C., the secondary battery 10 may be determined as a defective product in the determination step S3.

In the determination step S3, the temperature information from the temperature detection step S2 may be transmitted to a controller 400 such as a central processing unit (CPU).

Then, the controller 400 may analyze the transmitted temperature information and classify the secondary battery 10 into good or bad product.

The manufacturing method for a secondary battery according to an embodiment of the present disclosure may further include: a classification step, after the determination step S3, for storing secondary batteries 10 by classifying the secondary batteries 10 into good and bad products.

Secondary batteries 10 classified as good products are transported to the next secondary battery manufacturing process, and secondary batteries 10 classified as defective products may be recycled or discarded.

Above, the present disclosure has been described in detail through specific embodiments. The embodiments are for specifically explaining the present disclosure, and are only illustrative and do not limit the scope of the appended claims. It is obvious to those skilled in the art that various changes and modifications to the embodiments are possible within the scope and technical idea of the present disclosure, and it is natural that such changes and modifications fall within the scope of the appended claims.

What is claimed is:

1. A manufacturing method for a secondary battery, the method comprising:
a transport step for transporting a secondary battery;
a temperature detection step for detecting temperature of the secondary battery being transported in the transporting of the secondary battery; and
a determination step for determining whether the secondary battery is defective on the basis of temperature information obtained from the detecting of the temperature.

2. The method of claim 1, wherein in the temperature detection step, when the temperature of the secondary battery is detected, the transport of the secondary battery is stopped for a predetermined time and then the secondary battery is transported again.

3. The method of claim 1, wherein in the temperature detection step, the temperature of the secondary battery is detected using a non-contact temperature measurement means of either a thermal imaging camera or an infrared temperature sensor.

4. The method of claim 1, wherein in case that the information shows that the temperature is 30° C. or higher, the secondary battery is determined as a good product in the determining whether the secondary battery is defective.

5. The method of claim 1, further comprising:
a position detection step for detecting a position of the secondary battery being transported in the transport step.

6. The method of claim 5, wherein in the position detection step, presence or absence of the secondary battery is detected at a position where the temperature detection step is detected.

7. The method of claim 5, wherein in the position detection step, the secondary battery is detected after the secondary battery is transported for a predetermined time in the transport step.

8. The method of claim 1, further comprising:
a sealing step, before the transport step, for sealing a boundary between an accommodation portion that accommodates an electrode assembly and an electrolyte inside the secondary battery and a gas chamber that stores gas generated inside the secondary battery.

9. The method of claim 8, wherein in the temperature detection step, temperature of the boundary of the secondary battery is detected.
